(19) United States
(12) Patent Application Publication
(10) Pub. No.: US 2015/0272236 A1
(43) Pub. Date: Oct. 1, 2015

(54) Electrically-Heated Clothing/Pants and Its Accessories

(71) Applicant: PHIHONG TECHNOLOGY CO., LTD., Gueishan Township (TW)

(72) Inventors: Chun-Chen Chen, Gueishan Township (TW); Yu-Ching Huang, Gueishan Township (TW)

(21) Appl. No.: 14/583,431

(22) Filed: Dec. 26, 2014

(30) Foreign Application Priority Data
Apr. 1, 2014 (TW) 103205621

(51) Int. Cl. A41D 13/005; H05B 3/34

(52) U.S. Cl. CPC A41D 13/0051; H05B 3/342

(57) ABSTRACT

Embodiments of the electrically-heated clothing comprising: a clothing, at least one heater, at least one control element and at least one battery. At least one control element is set firmly on the clothing; wherein there are sewed multiple pockets on the clothing to place at least one heater, at least and at least one control element; wherein there are sewed multiple pockets on the front and back of the clothing to place at least one heater.

### FIELD OF THE INVENTION

The present invention relates to an electrically-heated clothing/pants and its accessories; more particularly, the present invention relates to an electrically-heated clothing/pants and its accessories that is provided for keeping specific body areas warm, and specific body areas are most sensitive to cold.

### BACKGROUND OF THE INVENTION

Currently electrically-heated clothing has multiple types of electric heating devices on the market. And wherein the electric heating device may further be of four types: laid electric heating wire, superconductive pellet, knitting conductive yarn and rubber electric heating piece in which the laid electric heating wire forms a high temperature via its contact heating by the way of utilization of laying down the electric heating wire in loops, but the present laid electric heating wire has several common disadvantages comprising: (1) the electric heating wire unevenly distributed leads to heat unevenly and cause to the effect of local overheating; (2) the electric heating wire doesn't have the waterproof itself, and if there is no additional waterproof clothing coated on the electric heating wire, the electric heating wire will produce metal oxidation corrosion in moist environment such as washing the clothes; (3) the electric heating wire sewed in the clothes, coupled with its hard characteristic, influences the shape and touch of the clothes; (4) there is any adhesive force between the electric heating wire and the clothes, thus the electric heating wire is easily dissociated from the clothes; (5) while bending the electric heating wire many times, the bending portion of the electric heating wire is broken easily and cause short circuit and leakage of electricity. Although the lighter carbon fiber heater has replaced the electric heating wire as the improvement technology of heating tools, but the disadvantages of the lighter carbon fiber heater are prohibitive, easily broken while receiving the force hit, absence of ductility and do not be supported under too large stress.

The superconductive pellet electric heating device uses the contacts of thin nickel film etched circuit to heat and form a high temperature, the front and reverse side of the thin nickel film are further attached with Mylar, a multirole plastic material, having the insulating function, while bending the electric heating wire many times, the bending portion of the electric heating wire is broken easily and cause short circuit and leakage of electricity.

In addition, the knitting conductive yarn uses fine wire, which is generally metal fibers as the conductive yarn and combines with the silk, then the knitting conductive yarn is sewed in the clothes, the electrically-heated clothing with the knitting conductive yarn electric heating device is more expensive, and because there are many contacts in the knitting conductive yarn, the knitting conductive yarn doesn't loss heating function while fine wire broken unless many fine wire is broken, but the fine wire still has the oxidation problem.

Moreover, the rubber electric heating piece is the safest heater known today. The rubber electric heating piece is made by a compounded rubber pressed and rolled to shape and the wire is embedded in the rubber to form many contacts without circuit problems, the temperature disperses on each area of the rubber equally. Although the rubber electric heating piece has solder contacts, but the solder point temperature doesn't form the aggregate temperature, the rubber electric heating piece may be bended many times without producing the fracture and short circuit condition, the rubber material also has better wear resistance, higher flexibility, higher tensile strength and elongation rate. However, the rubber is aged easily while it is exposed in the air, and the rubber becomes viscous easily on being heated. Additionally, due to currently the cell for commercial electrically-heated clothing use is the 7.4 voltage lithium battery, and the 7.4 voltage lithium battery is not easily purchased on market. Consequently, the 7.4 voltage lithium battery of the clothing is hard to be replaced if it was in trouble. The placement of laid electric heating wire, superconductive pellet, knitting conductive yarn or rubber electric heating piece in commercial electrically-heated clothing is not aimed at the body areas most sensitive to cold.

Therefore, as previously mentioned, it need to develop a new electrically-heated device for solving many problems as mentioned above.

### SUMMARY OF THE INVENTION

In view of the above known problems, the purpose of the invention is to provide an electrically-heated clothing/pants, and the electric heating piece in the electrically-heated clothing/pants is a silicone rubber electric heating piece, and the silicone rubber electric heating piece is consisting of a conducting element and a silicone rubber. Apart from its better electrical isolation, the silicone rubber also has better heat conduction and may absorb local thermal energy produced from the conducting element and thermal energy is evenly distributed in the silicone rubber, so it could improve the disadvantage about local overheating while using the electrically-heated clothing/pants, the user's surface contacted with the silicone rubber may be heated uniformly, the user is not scalded by the silicone rubber and the silicone rubber may keep the specific body areas warm. In addition, because the silicone rubber has better waterproof function, the electrically-heated clothing/pants will be washed in moist environment such as washing the clothes.

Another purpose of the invention is to provide an electrically-heated accessories aimed to keep the specific body areas warm, and specific body areas are most sensitive to cold, such as the soles of my feet, middle, head, neck and ears etc. The electric heating piece used in the electrically-heated accessories is also the silicone rubber electric heating piece. The silicone rubber of the silicone rubber electric heating piece may endure temperature up to 250° C. , so even if the conducting element has sudden overheating condition, the structure of the silicone rubber still may maintain better stability.

In a first aspect of the invention, the invention of the electrically-heated clothing comprises: a clothing, at least one heater, at least one control element, at least one battery. The at least one control element set on the clothing further comprises: a plug-in element and a microcontroller. The microcontroller is electrically connected with the plug-in element, the microcontroller is electrically connected with the at least one heater via a wire for multiple stages temperature control; at least one battery electrically is connected with the plug-in element via a wire; wherein there is at least one pocket sewed on the clothing for placing the at least one control element and the at least one battery; wherein a plurality of pockets are sewed on the clothing, several pockets on the front of clothing and several pockets on the back of clothing, and the at least one heater is placed separately in the plurality of pockets.

In a second aspect of the invention, the invention of the electrically-heated pair of pants comprises: a pair of pants, at least one heater, at least one control element, at least one battery. The at least one control element set on the pair of pants further comprises: a plug-in element and a microcontroller. The microcontroller is electrically connected with the plug-in element, the microcontroller is electrically connected with the at least one heater via a wire for multiple stages temperature control; at least one battery electrically is connected with the plug-in element via a wire; wherein there is at least one pocket sewed on the pair of pants for placing the at least one control element and the at least one battery; wherein a plurality of pockets are sewed on the pair of pants, several pockets on the seat of pants and several pockets on the leg of pants, and the at least one heater is placed separately in the plurality of pockets; wherein the at least one heater in the electrically-heated clothing/pants is a silicone rubber electric heating piece.

In a third aspect of the invention, the invention provides an electrically-heated accessory and further comprises: an accessory, at least one heater, at least one control element, at least one battery. The at least one control element set on the accessory further comprises: a plug-in element and a microcontroller. The microcontroller is electrically connected with the plug-in element, the microcontroller is electrically connected with the at least one heater via a wire for multiple stages temperature control; at least one battery electrically is connected with the plug-in element via a wire; wherein there is at least one pocket sewed on the accessory for placing the at least one control element and the at least one battery; wherein a plurality of pockets are sewed on the accessory, and the at least one heater is placed separately in the plurality of pockets; additionally, the at least one heater in the electrically-heated accessory is a silicone rubber electric heating piece.

In a fourth aspect of the invention, the invention provides another electrically-heated accessory and further comprises: an accessory, a bandage, at least one heater, at least one control element, at least one battery. The at least one control element set on the bandage further comprises: a plug-in element and a microcontroller. The microcontroller is electrically connected with the plug-in element, the microcontroller is electrically connected with the at least one heater via a wire for multiple stages temperature control; wherein at least one battery electrically is connected with the plug-in element via a wire; wherein a plurality of pockets are sewed on the bandage for placing the at least one control element and the at least one battery; the at least one heater in the electrically-heated accessory is a silicone rubber electric heating piece.

The batteries used in the electrically-heated clothing/pants and its accessories may also be common 5V lithium batteries.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is illustrated as a diagram of component configuration of an electrically-heated clothing.

FIG. 2 is illustrated as a diagram of component configuration of another electrically-heated clothing.

FIG. 3 is illustrated as a diagram of component configuration of an electrically-heated pair of pants.

FIG. 4 is illustrated as a diagram of component configuration of an electrically-heated gloves.

FIG. 5 is illustrated as a diagram of component configuration of an electrically-heated belt.

FIG. 6 is illustrated as a diagram of component configuration of an electrically-heated insole.

### DETAILED DESCRIPTION OF THE PRESENT INVENTION

An implementation of the invention is illustrated by the following specific embodiments, the person who is familiar with the technique may easily realize the efficiency and its advantages disclosed from the specification content. The invention also may use other specific embodiments to utilize and implement, each detail illustrated in the specification may be applied based on different needs and various kinds of modifications and alterations are not departed under the spirit of the invention.

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

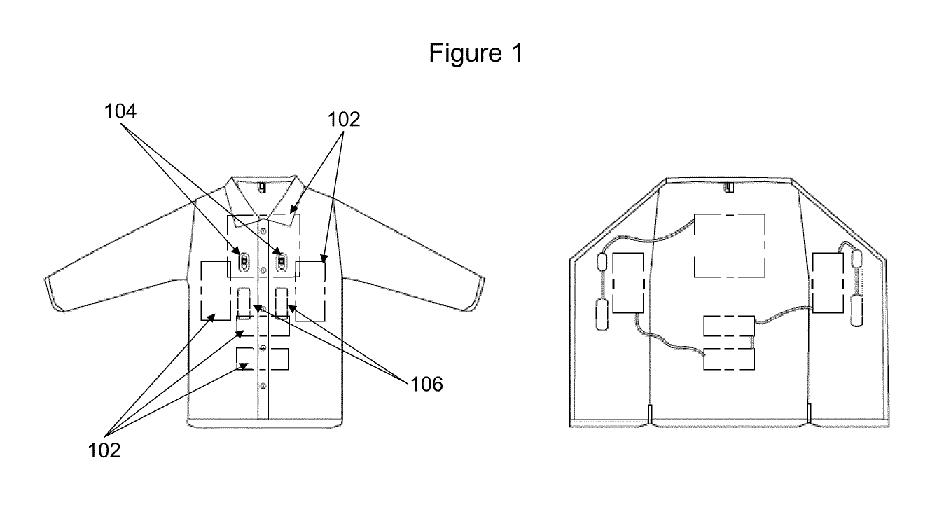

As shown in FIG. 1, it is illustrated as a diagram of component configuration of an electrically-heated clothing. The embodiment of the electrically-heated clothing further includes: a clothing, at least one battery 106, at least one heater 102, at least one control element 104. The at least one control element set on the clothing further comprises: a plug-in element and a microcontroller. The microcontroller is electrically connected with the plug-in element, the microcontroller is electrically connected with the at least one heater via a wire for multiple stages temperature control; at least one battery electrically is connected with the plug-in element via a wire; wherein there is at least one pocket sewed on the clothing for placing the at least one control element and the at least one battery; wherein a plurality of pockets are sewed on the clothing, several pockets on the front of clothing and several pockets on the back of clothing, and the at least one heater is placed separately in the plurality of pockets; wherein the at least one heater in the electrically-heated clothing is a silicone rubber electric heating piece.

In some embodiments, there are two pockets sewed on the front of electrically-heated clothing, and there are three pockets sewed on the back of electrically-heated clothing, then the heating elements are placed separately in said pockets. The presentation of heaters in the front of electrically-heated clothing is designed for keeping the chest and heart areas warm; additionally, the presentation of heaters in the back of electrically-heated clothing is designed for keeping the back and waist areas warm, then the battery is placed into other pockets, and two control elements are set on the front of electrically-heated clothing, there are two pockets sewed under said two control elements on the front of clothing for placement of two batteries.

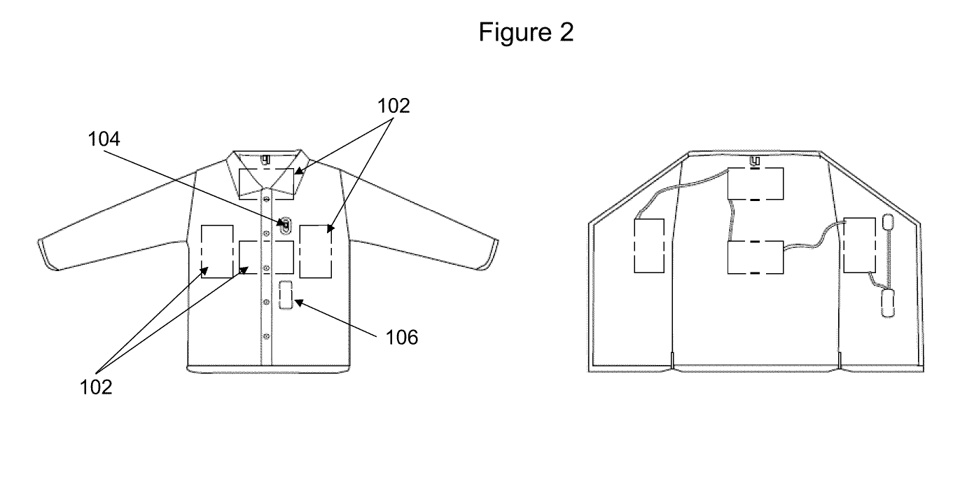

In one embodiment, as shown in FIG. 2, several pockets are sewed on the clothing and there are two pockets sewed on the front of clothing, and there are two pockets sewed on the back of clothing, then heaters are placed separately in said pockets, and wherein one control element is set on the front of electrically-heated clothing, there is one pocket additionally sewed under said control element on the front of clothing for placement of the battery.

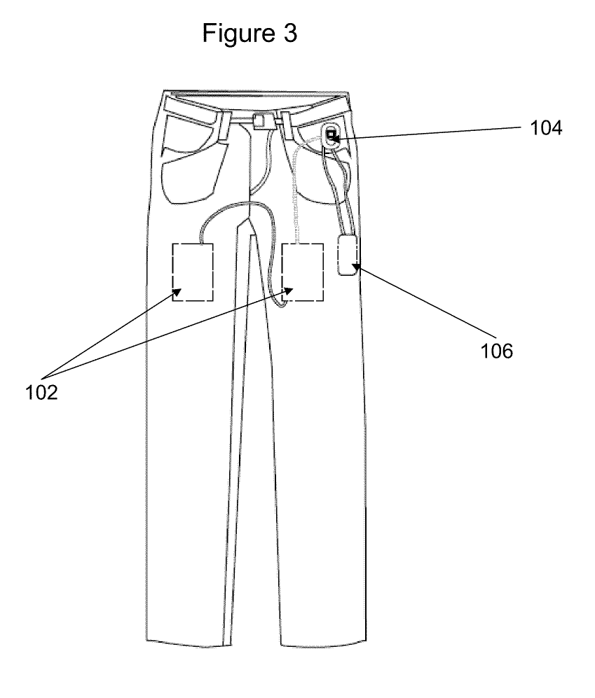

As shown in FIG. 3, it is illustrated as a diagram of component configuration of an electrically-heated pair of pants. The embodiment of the electrically-heated pair of pants further includes: a pair of pants, at least one battery 106, at least one heater 102, at least one control element 104. The at least one control element set on the pair of pants further comprises: a plug-in element and a microcontroller. The microcontroller is electrically connected with the plug-in element, the microcontroller is electrically connected with the at least one heater via a wire for multiple stages temperature control; at least one battery electrically is connected with the plug-in element via a wire; wherein there is at least one pocket sewed on the pair of pants for placing the at least one control element and the at least one battery; wherein a plurality of pockets are sewed on the pair of pants, and the at least one heater is placed separately in the plurality of pockets; wherein the at least one heater in the electrically-heated pair of pants is a silicone rubber electric heating piece.

In one embodiment, there are three pockets sewed on the pair of pants, one pocket on the seat of pants and two pockets on the leg of pants, then the at least one heater is placed separately in said pockets. The presentation of heaters in the electrically-heated pair of pants is designed for keeping the seat and leg areas warm. In one embodiment, there are four pockets sewed on the pair of pants, two pocket on the seat of pants and two pockets on the leg of pants, then the heaters are placed separately in said pockets.

In some embodiments, there is one control element is set on the waist of electrically-heated pair of pants, there is one pocket additionally sewed under said control element on the front of clothing for placement of the battery.

In some embodiments, silicone rubber electric heating pieces used in the electrically-heated clothing/pants utilize the silicone rubber as insulators to coat the conducting element completely, the silicone rubber may fully absorb thermal energy produced from the conducting element, wherein the battery used by the electrically-heated clothing/pants is the 5V lithium battery. In one embodiment, the battery used by the electrically-heated clothing/pants is a graphene battery.

The invention may be apply to electrically-heated accessories. The embodiment of the electrically-heated accessory further includes: an accessory, at least one battery 106, at least one heater 102, at least one control element 104, the at least one heater is a silicone rubber electric heating piece. The at least one control element set on the accessory further comprises: a plug-in element and a microcontroller. The microcontroller is electrically connected with the plug-in element, the microcontroller is electrically connected with the at least one heater via a wire for multiple stages temperature control; at least one battery electrically is connected with the plug-in element via a wire; wherein there is at least one pocket sewed on the accessory for placing the at least one control element and the at least one battery; wherein a plurality of pockets are sewed on the accessory, several pockets on the front of accessory and several pockets on the back of accessory, and the at least one heater is placed separately in the plurality of pockets. In one embodiment, the accessory may also be the gloves, belt and scarf.

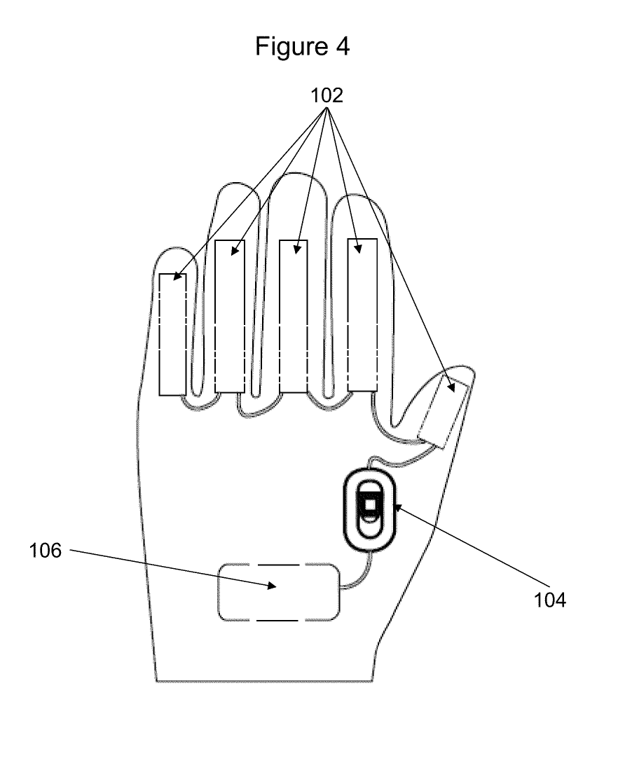

As shown in FIG. 4, it is illustrated as a diagram of component configuration of an electrically-heated gloves, wherein five pockets are sewed on the fingers of gloves, and the at least one heater is placed separately in the plurality of pockets, wherein one control element is set on the side of the thumb of gloves, and there is one pocket additionally sewed on the palm of gloves for placement of one battery.

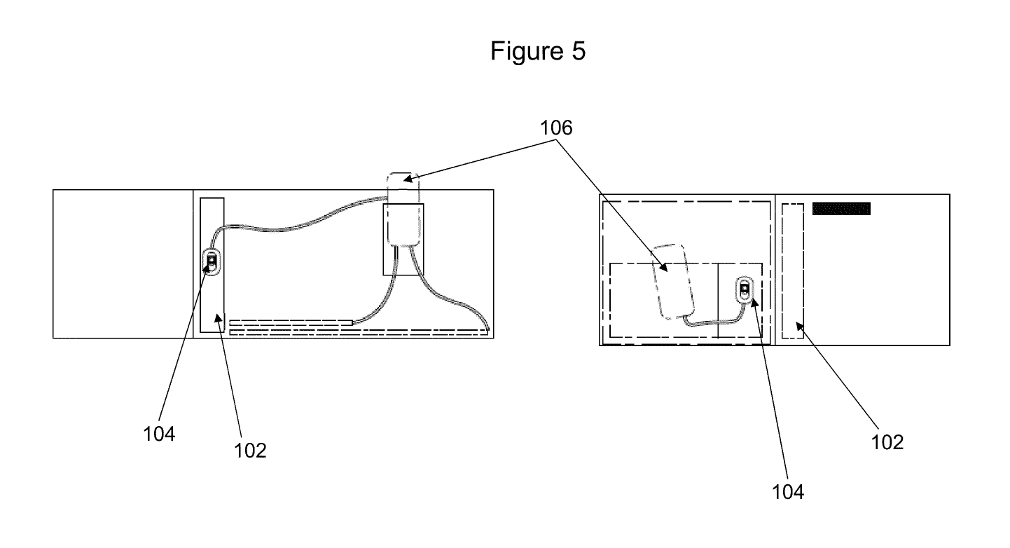

As shown in FIG. 5, it is illustrated as a diagram of component configuration of an electrically-heated belt, wherein one pocket is sewed on the electrically-heated belt and one heater is placed in said pocket, wherein one control element is set on the electrically-heated belt, and there is one pocket additionally sewed on the electrically-heated belt for placement of one battery. In one embodiment, wherein one pocket is sewed on the electrically-heated scarf and one heater is placed in said pocket, and one control element is set on the electrically-heated scarf, and there is one pocket additionally sewed on the electrically-heated scarf for placement of one battery.

In someone embodiment, an electrically-heated accessory comprises: an accessory, a bandage 202, at least one heater 102, at least one control element 104, at least one battery 106. The at least one control element set on the bandage further comprises: a plug-in element and a microcontroller. The microcontroller is electrically connected with the plug-in element, the microcontroller is electrically connected with the at least one heater via a wire for multiple stages temperature control; the at least one heater is further a silicone rubber electric heating piece; in addition, at least one battery electrically is connected with the plug-in element via a wire; wherein a plurality of pockets are sewed on the bandage for placing the at least one control element and the at least one battery.

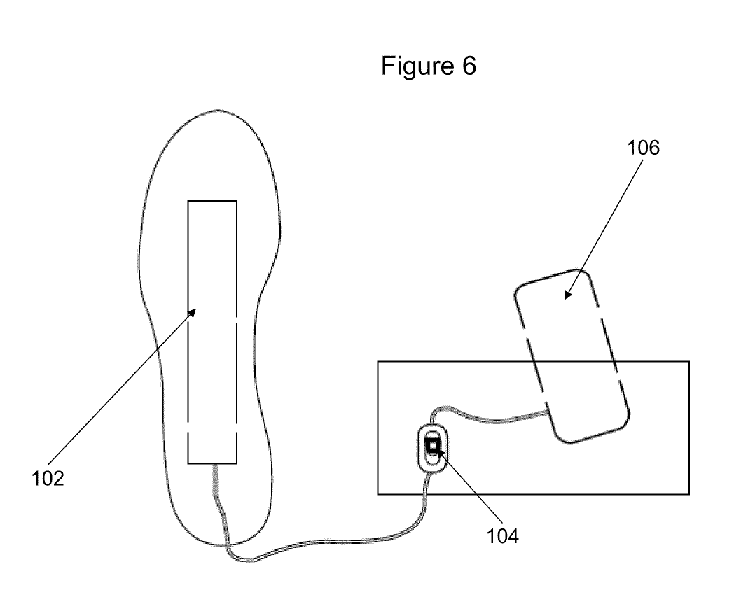

As shown in FIG. 6, in some embodiments, the accessory may also be an electrically-heated insole, wherein one pocket is sewed on the bottom of insole and the at least one heater is placed in said pocket. In another embodiment, wherein the accessory may also be an electrically-heated earmuffs, wherein one pocket is sewed on the inner of earmuffs and one heater is placed in said pocket. Moreover, the battery used in the electrically-heated gloves, belt, insole and earmuffs is the 5V lithium battery. The heaters used in the electrically-heated insole and earmuffs utilize silicone rubber electric heating pieces.

The foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

1. An electrically-heated clothing, comprising:
a clothing;
at least one heater, and the at least one heater is a silicone rubber electric heating piece; and
at least one control element set on the clothing further comprising:
a plug-in element;
a microcontroller electrically connected with the plug-in element, the microcontroller electrically connected with the at least one heater via a wire for multiple stages temperature control;
at least one battery electrically connected with the plug-in element via a wire;
wherein there is at least one pocket sewed on the clothing for placing the at least one control element and the at least one battery; wherein a plurality of pockets are sewed on the clothing, several pockets on the front of clothing and several pockets on the back of clothing, and the at least one heater is placed separately in the plurality of pockets.

2. The clothing of claim 1, wherein there are two pockets sewed on the front of clothing, and there are three pockets sewed on the back of clothing, then the at least one heater is placed separately in said pockets.

3. The clothing of claim 1, wherein there are two pockets sewed on the front of clothing, and there are two pockets sewed on the back of clothing, then the at least one heater is placed separately in said pockets.

4. The clothing of claim 1, wherein there are two pockets sewed on the front of clothing, then the at least one battery is placed separately in said pockets.

5. The clothing of claim 1, wherein the at least one battery is a 5V lithium battery.

6. An electrically-heated pants, comprising:
a pair of pants;
at least one heater, and the at least one heater is a silicone rubber electric heating piece; and
at least one control element set on the pair of pants further comprising:
a plug-in element;
a microcontroller electrically connected with the plug-in element, the microcontroller electrically connected with the at least one heater via a wire for multiple stages temperature control;
at least one battery electrically connected with the plug-in element via a wire;
wherein there is at least one pocket sewed on the pair of pants for placing the at least one control element and the at least one battery; wherein a plurality of pockets are sewed on the pair of pants, several pockets on the seat of pants and several pockets on the leg of pants, and the at least one heater is placed separately in the plurality of pockets.

7. The pants of claim 6, wherein there are three pockets sewed on the pair of pants, one pocket on the seat of pants and two pockets on the leg of pants and the at least one heater is placed separately in said pockets.

8. The pants of claim 6, Wherein there is one pockets sewed on the leg of pants and the at least one battery is placed separately in said pockets.

9. An electrically-heated accessory, comprising:
an accessory;
at least one heater, and the at least one heater is a silicone rubber electric heating piece; and
at least one control element set on the accessory further comprising:
a plug-in element;
a microcontroller electrically connected with the plug-in element, the microcontroller electrically connected with the at least one heater via a wire for multiple stages temperature control;
at least one battery electrically connected with the plug-in element via a wire;
wherein there is at least one pocket sewed on the accessory for placing the at least one control element and the at least one battery; wherein a plurality of pockets are sewed on the accessory, and the at least one heater is placed separately in the plurality of pockets.

10. The accessory of claim 9, wherein the accessory is a gloves, and wherein five pockets are sewed on the fingers of gloves.

11. The accessory of claim 9, wherein the accessory is a belt, and wherein one pocket is sewed on the belt and the at least one heater is placed in said pocket.

12. The accessory of claim 9, wherein the accessory is a scarf, and wherein one pocket is sewed on the scarf and the at least one heater is placed in said pocket.

13. An electrically-heated accessory, comprising:
an accessory;
a bandage;
at least one heater, and the at least one heater is a silicone rubber electric heating piece; and
at least one control element set on the bandage further comprising:
a plug-in element;
a microcontroller electrically connected with the plug-in element, the microcontroller electrically connected with the at least one heater via a wire for multiple stages temperature control;
at least one battery electrically connected with the plug-in element via a wire;
wherein there is at least one pocket sewed on the bandage for placing the at least one control element and the at least one battery.

14. The accessory of claim 13, wherein the accessory is an insole, and wherein one pocket is sewed on the bottom of insole and the at least one heater is placed in said pocket.

15. The accessory of claim 13, wherein the accessory is an earmuffs, and wherein one pocket is sewed on the inner of earmuffs and the at least one heater is placed in said pocket.

16. The accessory of claim 9, wherein the at least one battery is a 5V lithium battery.

17. The accessory of claim 13, wherein the at least one battery is a 5V lithium battery.
